(19) United States
(12) Patent Application Publication
(10) Pub. No.: US 2025/0242704 A1
(43) Pub. Date: Jul. 31, 2025

(54) VEHICLE DRIVE SOURCE DEVICE

(71) Applicant: Isuzu Motors Limited, Yokohama-shi (JP)

(72) Inventor: Wataru OKADA, Fujisawa-shi (JP)

(73) Assignee: Isuzu Motors Limited, Yokohama-shi (JP)

(21) Appl. No.: 19/019,677

(22) Filed: Jan. 14, 2025

(30) Foreign Application Priority Data
Jan. 30, 2024 (JP) 2024-011935

(51) Int. Cl. B60L 50/60; B60L 58/10; H02J 7/00

(52) U.S. Cl. CPC B60L 50/60; B60L 58/10; H02J 7/0047; H02J 7/0063

(57) ABSTRACT

A vehicle drive source device includes: a battery capable of supplying power to a driving motor of a vehicle through a high-voltage line; a battery monitoring section that includes an integrated circuit connected to the high-voltage line and detecting a voltage of the battery between terminals, and is driven by a low-voltage power supply as a power source; a battery case that houses each of the battery and the battery monitoring section; a vehicle ground connection section that is electrically connected to a vehicle ground; and a connection line, and the integrated circuit is electrically connected to the vehicle ground connection section through the connection line.

### CROSS REFERENCE TO RELATED APPLICATIONS

This application is a Paris Convention Application which claims the benefit of priority of Japanese Patent Application No. 2024-011935 filed on Jan. 30, 2024. The contents of the above application is all incorporated by reference as if fully set forth herein in its entirety.

### TECHNICAL FIELD

The present disclosure relates to a drive source device for a vehicle (hereinafter, referred to as vehicle drive source device).

### BACKGROUND ART

An Electric Vehicle (EV) or a hybrid vehicle drives a vehicle by supplying electric power charged in a battery (secondary battery) to an electric motor. The vehicle is equipped with a battery pack that supplies high-voltage power. The battery pack includes a battery monitoring section for monitoring the state of each built-in battery.

For example, Patent Literature (hereinafter, referred to as PTL) 1 discloses a vehicle control unit including: a control unit connectable at least to a first power supply line of a vehicle; one or more loads connectable to a downstream side of the control unit; a detachable internal rechargeable battery; and a housing configured to accommodate the control unit and the internal rechargeable battery therein, in which the control unit is configured to selectively supply, to the one or more loads, one of first power-supply electric power supplied from the first power supply line and second power-supply electric power supplied from the internal rechargeable battery depending on a situation. Further, the control unit is connected to the ground through a connector, and the battery is connected to the ground.

For example, in PTL 2, a power supply line and a ground line are connected to a control device through a connector, and the power supply line and the ground line are also connected to a battery.

### CITATION LIST

### Patent Literature

PTL 1

Japanese Patent Application Laid-Open No. 2023-19094

PTL 2

Japanese Patent Application Laid-Open No. 2020-168910

### SUMMARY OF INVENTION

### Technical Problem

FIG. 1 is a schematic wiring diagram of a vehicle drive source device according to a comparative example. Battery pack 1 includes a plurality of battery cells 1c connected in series. The voltage of battery pack 1 is an integrated value obtained by multiplying the voltage per battery cell 1c by the number of battery cells 1c. Integrated circuits 2 are arranged corresponding to battery cells 1c from battery cell 1c in the foremost row to battery cell 1c in the rearmost row. Integrated circuits 2 are each a voltage detector for detecting a voltage between terminals of battery cells 1c. Integrated circuits 2 are housed in circuit case 4 of battery monitoring section 3. Battery pack 1 and battery monitoring section 3 are housed in battery case 5. Battery pack 1 mounted in an EV is required to be highly safe. For example, in a case where the portion to be insulated is not sufficiently insulated and the insulation resistance is insufficient, the battery life is possibly deteriorated. In order to confirm that an adequate insulation resistance is ensured, a withstand voltage test/insulation resistance test is performed for each of the plurality of battery cells 1c. In the withstand voltage test/insulation resistance test, one terminal of insulation resistance meter 6 is connected to a positive or a negative terminal (negative terminal in FIG. 1) of battery cell 1c in the rearmost row through high-voltage line HVL and high-voltage connector HVC, the other terminal of insulation resistance meter 6 is connected to battery case 5 (ground), and a predetermined voltage is applied.

Integrated circuits 2 are connected to high-voltage connector HVC through a voltage detection harness in battery pack 1 and high-voltage line HVL. Further, a ground line is connected to grounds of integrated circuits 2 from battery case 5 through circuit case 4. Thus, in the withstand voltage test/insulation resistance test, a high-voltage obtained by summing a predetermined voltage applied to insulation resistance meter 6 and a voltage (integrated value) of the battery pack is applied to integrated circuit 2 arranged corresponding to battery cell 1c in the rearmost row (integrated circuit 2 arranged at the uppermost portion in FIG. 1). As a result, a high load is applied to integrated circuit 2, so that the durability of integrated circuit 2 possibly decreases, and integrated circuit 2 having low pressure tightness is possibly damaged.

An object of the present disclosure to provide a vehicle drive source device capable of suppressing a decrease in the durability of the integrated circuit and avoiding damage to the integrated circuit.

### Solution to Problem

To archive the above object, a vehicle drive source device includes:
a battery capable of supplying power to a driving motor of a vehicle through a high-voltage line;
a battery monitoring section that includes an integrated circuit connected to the high-voltage line and detecting a voltage of the battery between terminals, and is driven by a low-voltage power supply as a power source;
a battery case that houses each of the battery and the battery monitoring section;
a vehicle ground connection section that is electrically connected to a vehicle ground; and
a connection line, and
the integrated circuit is electrically connected to the vehicle ground connection section through the connection line

### Advantageous Effects of Invention

According to the present disclosure, it is possible to suppress a decrease in the durability of the integrated circuit and to avoid damage to the integrated circuit.

### BRIEF DESCRIPTION OF DRAWINGS

FIG. 1 is a schematic wiring diagram of a vehicle drive source device according to a comparative example;

FIG. 2 is a schematic wiring diagram of a vehicle drive source device according to an embodiment of the present disclosure; and

FIG. 3 is a perspective view of a drive source device according to the embodiment of the present disclosure.

### DESCRIPTION OF EMBODIMENTS

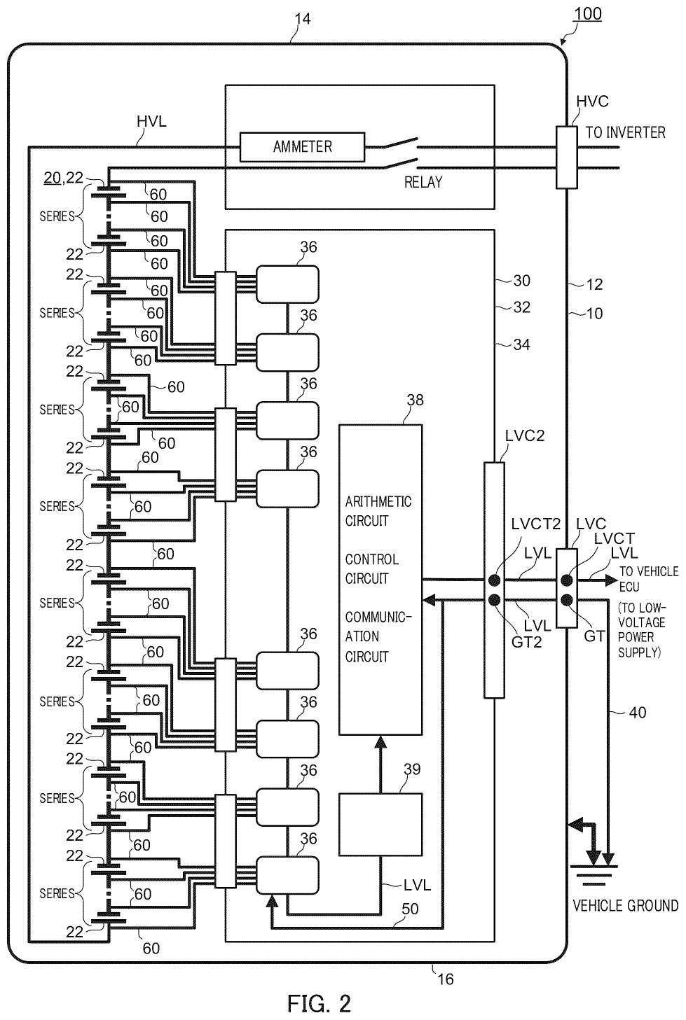

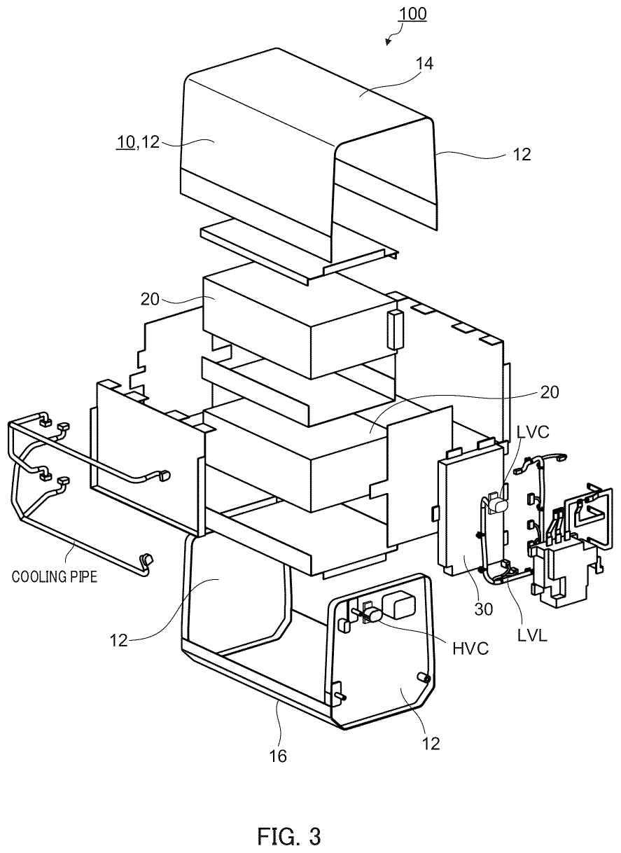

Hereinafter, an embodiment of the present disclosure will be described with reference to the drawings. FIG. 2 illustrates a ground connection structure of a vehicle drive source device according to the embodiment of the present disclosure. FIG. 3 is a perspective view of the ground connection structure of the vehicle drive source device according to the embodiment of the present disclosure. Vehicle drive source device 100 according to the present embodiment includes battery case 10, battery pack 20, battery monitoring section 30, ground harness 40, connection line 50, and voltage detection harness 60. Connection line 50 includes a wiring pattern, a harness, and an aluminum wire disposed on the circuit board.

Battery case 10 has an internal space, and includes peripheral walls 12 placed around the internal space, top plate 14 placed at an upper position of the internal space, and bottom wall 16 placed at a lower position of the internal space. In the internal space of battery case 10, battery pack 20 and battery monitoring section 30 are housed. Battery case 10 is, for example, a casing made of metal, such as a sheet metal press component or an aluminum die cast component.

High-voltage connector HVC is disposed on peripheral wall 12. High-voltage connector HVC includes a positive terminal and a negative terminal. The positive terminal of battery pack 20 is connected to a positive terminal of an inverter through high-voltage line HVL and the positive terminal of high-voltage connector HVC. The negative terminal of battery pack 20 is connected to the negative terminal of the inverter through high-voltage line HVL and the negative terminal of high-voltage connector HVC.

Low-voltage connector LVC is disposed on peripheral wall 12. Low-voltage connector LVC is electrically connected to a low-voltage power supply. Low-voltage connector LVC includes ground terminal GT and low-voltage connector terminal LVCT. Ground terminal GT is connected to a vehicle ground (also referred to as “chassis ground”) through ground harness 40.

Low-voltage connector terminal LVCT is connected to a vehicle Electronic Control Unit (ECU) through low-voltage line LVL.

A cooling pipe is disposed along the peripheral wall of battery pack 20. Battery pack 20 includes a plurality of battery cells 22. The plurality of battery cells 22 is connected in series or in parallel. A specified capacity and a specified output current of battery pack 20 are set depending on the number of battery cells 22 connected in series or in parallel.

Battery monitoring section 30 includes circuit case 32, printed circuit board 34, a plurality of integrated circuits 36, electronic circuit 38, transceiver circuit 39, second low-voltage connector LVC2, and connection line 50. Printed circuit board 34 and the plurality of integrated circuits 36 are housed in circuit case 32. The plurality of integrated circuits 36 is placed on printed circuit board 34. Second low-voltage connector LVC2 is attached to printed circuit board 34. Second low-voltage connector LVC2 includes second ground terminal GT2 and second low-voltage connector terminal LVCT2. Second ground terminal GT2 is connected to ground terminal GT of low-voltage connector LVC through low-voltage line LVL. Second ground terminal GT2 is connected to each of the plurality of integrated circuits 36 through connection line 50. Note that low-voltage connector LVC and second low-voltage connector LVC2 correspond to a “vehicle ground connection section” of the present disclosure.

Second low-voltage connector terminal LVCT2 is connected to low-voltage connector terminal LVCT through low-voltage line LVL. Electronic circuit 38 includes an arithmetic circuit, a control circuit, and a communication circuit. Electronic circuit 38 is connected to second low-voltage connector terminal LVCT2 through low-voltage line LVL. Transceiver circuit 39 is connected to the plurality of integrated circuits 36 through low-voltage line LVL. Transceiver circuit 39 controls communication between each of the plurality of integrated circuits 36 and electronic circuit 38.

The plurality of integrated circuits 36 are arranged to correspond to a plurality of battery cells 22, and are each connected, with voltage detection harness 60, to each of the positive terminals and the negative terminals of battery cells 22 arranged corresponding to integrated circuit 36. Thus, integrated circuit 36 can detect the voltage between terminals of battery cells 22. Battery monitoring section 30 monitors the states of battery cells 22 based on the detection results of integrated circuits 36.

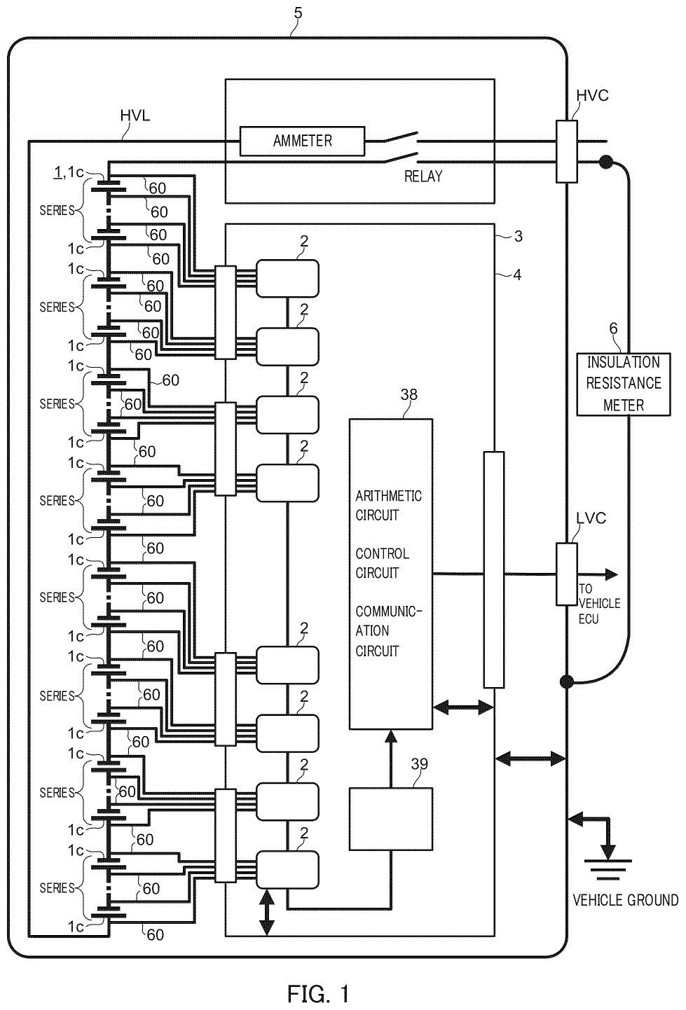

Next, a withstand voltage test/insulation resistance test is described. In the withstand voltage test/insulation resistance test, one terminal of insulation resistance meter 6 (see FIG. 1) is connected to the positive or negative terminal (negative terminal in FIG. 2) of battery cell 22 in the rearmost row through high-voltage line HVL and high-voltage connector HVC, the other terminal of insulation resistance meter 6 is connected to battery case 10 (ground), and a predetermined voltage is applied.

Integrated circuits 36 are connected to high-voltage connector HVC through high-voltage line HVL in battery pack 20. Note that the ground line is connected to the grounds of integrated circuits 36 from a vehicle ground (chassis ground) in another system different from the system connected to the grounds of integrated circuits 36 from battery case 10 (ground). Specifically, the ground line is connected to the grounds of integrated circuits 2 through the vehicle ground (chassis ground), ground harness 40, low-voltage connector LVC, second low-voltage connector LVC2, and connection line 50. Thus, the ground connection line leading to integrated circuits 36 and the ground of battery case 10 are separated, so that, in the withstand voltage test/insulation resistance test, a voltage is not applied to integrated circuits 36 and a high load is not applied to integrated circuits 36, which suppresses a decrease in the durability of integrated circuits 36 and avoids damage to integrated circuit 36 having low pressure tightness.

Vehicle driving source device 100 according to the above embodiment includes: a battery (battery pack 20) capable of supplying power to a driving motor of a vehicle through a high-voltage line; battery monitoring section 30 that includes integrated circuit 36 connected to a high-voltage line and detecting a voltage between terminals of the battery and is driven by a low-voltage power supply as its power source; battery case 10 that houses the battery and battery monitoring section 30; a vehicle ground connection section (low-voltage connector LVC, second low-voltage connector LVC2) that is electrically connected to a vehicle ground (chassis ground); and connection line 50. Integrated circuit 36 is electrically connected to the vehicle ground connection section through connection line 50. Further, the vehicle ground connection section is electrically connected to the vehicle ground through ground harness 40.

According to the above configuration, in a case where, in a withstand voltage test/insulation resistance test, one terminal of insulation resistance meter 6 is connected to the positive or negative terminal of battery cell 22 in the rearmost row, and the other terminal of insulation resistance meter 6 is connected to battery case 10 (ground) to apply a predetermined voltage, a ground line is connected to integrated circuit 36 from a vehicle ground (chassis ground) through ground harness 40 and connection line 50 in a system different from the system connected to the ground of integrated circuit 36 from battery case 10 (ground). Thus, in the withstand voltage test/insulation resistance test, the line leading to ground harness 40 and connection line 50, and ground harness 40 leading to battery case 10 are not connected to each other at the time of inspection, and thus a high load is no applied to integrated circuit 36 through ground harness 40 and connection line 50, which can suppress a decrease in the durability of integrated circuit 36. Further, it is possible to avoid damage to integrated circuit 36 having low pressure tightness. In addition, a withstand voltage test or the like can be performed during the assembly of vehicle drive source device 100, and thus a pressure tightness failure due to the assembly failure occurring during the assembly can be detected. Furthermore, separating the distance between wires eliminates the need of increasing the dielectric strength of integrated circuit 36, which suppresses an increase in the size and the cost of the device.

In vehicle drive source device 100 according to the above-described embodiment, the vehicle ground connection section includes low-voltage connector LVC that includes ground terminal GT electrically connected to the vehicle ground, and integrated circuit 36 is electrically connected to ground terminal GT through connection line 50. Thus, the ground line is connected to integrated circuit 36 from the vehicle ground (chassis ground) by connecting the ground line to ground terminal GT through connection line 50, which makes it possible to enhance the assembly workability.

Further, vehicle drive source device 100 according to the above-described embodiment, low-voltage connector LVC is electrically connected to a low-voltage power supply. Accordingly, providing ground terminal GT to low-voltage connector LVC electrically connected to a low-voltage power supply allows for a reduction in the number of components.

Furthermore, in vehicle drive source device 100 according to the above-described embodiment, low-voltage connector LVC is disposed outside battery case 10. Thus, low-voltage connector LVC can be accessed from the outside of battery case 10, which further enhances the assembly workability.

Moreover, in vehicle drive source device 100 according to the above-described embodiment, battery monitoring section 30 includes second low-voltage connector LVC2 that includes second ground terminal GT2, integrated circuit 36 is electrically connected to second ground terminal GT2 through connection line 50, and second ground terminal GT2 is electrically connected to ground terminal GT through the second low-voltage line. Thus, the ground line is connected from the vehicle ground (chassis ground) to integrated circuit 36 by connecting the ground line to second ground terminal GT2 through connection line 50, which further enhances the assembly workability.

Note that, in the above-described embodiment, a vehicle ground connection section using a connector (low-voltage connector LVC and second low-voltage connector LVC2) has been described, but the present disclosure is not limited thereto, and a vehicle ground connection section not using a connector that connects integrated circuit 36 and the vehicle ground with a harness may be applied.

The above-described embodiment is merely exemplary implementation of the present disclosure, and the technical scope of the present disclosure should not be construed as limited by the embodiment. That is, the present disclosure can be implemented in various forms without departing from its spirit or key features.

### INDUSTRIAL APPLICABILITY

The present disclosure is suitably used for a vehicle including a vehicle drive source device required to suppress a decrease in the durability of the integrated circuit and avoid damage to the integrated circuit.

1. A vehicle drive source device, comprising:
a battery capable of supplying power to a driving motor of a vehicle through a high-voltage line;
a battery monitoring section that includes an integrated circuit connected to the high-voltage line and detecting a voltage of the battery between terminals, and is driven by a low-voltage power supply as a power source;
a battery case that houses each of the battery and the battery monitoring section;
a vehicle ground connection section that is electrically connected to a vehicle ground; and
a connection line, wherein
the integrated circuit is electrically connected to the vehicle ground connection section through the connection line.

2. The vehicle drive source device according to claim 1, wherein
the vehicle ground connection section includes a low-voltage connecter including a ground terminal electrically connected to the vehicle ground, and
the integrated circuit is electrically connected to the ground terminal through the connection line.

3. The vehicle drive source device according to claim 2, wherein
the low-voltage connector is electrically connected to the low-voltage power supply.

4. The vehicle drive source device according to claim 3, wherein
the low-voltage connector is disposed outside the battery case.

5. The vehicle drive source device according to claim 2, wherein
the battery monitoring section includes a second low-voltage connector including a second ground terminal,
the integrated circuit is electrically connected to the second ground terminal through the connection line, and
the second ground terminal is electrically connected to the ground terminal through a second low-voltage line.
